(19) United States
(12) Patent Application Publication
(10) Pub. No.: US 2002/0092591 A1
(43) Pub. Date: Jul. 18, 2002

(54) Tapered tire groove configuration

(76) Inventor: Max Cortes, Richmond (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 09/760,662

(22) Filed: Jan. 17, 2001

(51) Int. Cl. B60C 11/00

(52) U.S. Cl. 152/209.18; 152/209.16

(57) ABSTRACT

This invention relates to a novel configuration of the grooves which traverse the surface of tires. This invention provides a tapered groove configuration which tends to reduce loss of traction due to accumulation of debris on the surface of the tire. A tire with the tapered groove configuration of this invention has grooves in which the width of the upper portion of the groove is always wider that the width of the lower portion of the groove.

### FIELD OF THE INVENTION

This invention relates to a novel configuration of the grooves which traverse the surface of tires. This invention provides a groove configuration which tends to reduce loss of traction due to accumulation of debris on the surface of the tire.

### BACKGROUND OF THE INVENTION

Of the myriad of individual components that make up a motor vehicle, only the tires directly control the motion of the vehicle because only the tires are in direct contact with the ground. All of the other navigational control mechanisms in a motor vehicle are dedicated to controlling the tires, which in turn determine how the vehicle manoeuvres. Different types of tires are best suited to different types of road conditions. For example, in auto racing, the cars will be fitted with slicks (ungrooved tires) for dry conditions and grooved tires for wet conditions. It is not practical, however, for the average motor vehicle owner to have a different set of tires for different conditions. Much research, therefore, has gone into developing tires that maximize traction in a wide range of road conditions.

There are currently a number of different types of tire available in the marketplace which are purported to be well-suited for all types of road conditions. These tires have a wide variety of patterns of grooves on their surface. However, while the groove patterns may be different, the grooves themselves all have generally parallel walls. This groove configuration allows mud, snow, small rocks, and other debris to become trapped in the grooves, resulting in a partial loss of traction, and, in the case of small rocks becoming trapped in a groove, unwanted noise.

There exists a need for a groove configuration which minimizes the likelihood that debris will become trapped in the grooves. The groove configuration should maintain traction in a variety of road conditions, and be cost-effective from a manufacturing standpoint.

### SUMMARY OF THE INVENTION

This invention provides a tapered groove configuration in which the top of the groove is substantially wider than the bottom of the groove. “Top of the groove” means the groove opening at the outer surface of the tire, and “bottom of the groove” means the part of the groove which is nearest to the axis of rotation of the tire.

Any debris in the grooves will tend to fall out of the grooves as the tire rotates, both due to gravity and to the fact that each point on the surface of a rotating tire is continually accelerating towards the center of the tire. Without sufficient frictional force between debris and the walls of the grooves, the debris will simply fall away from the tire. The groove configuration of this invention reduces the frictional force between debris and the walls of the grooves, thereby decreasing the likelihood that debris will become lodged in the grooves.

A preferred embodiment of this invention provides for a tire having side walls and a tread with an outer surface, said outer surface of the tread having a set of grooves thereon, each of said grooves extending radially inward from said outer surface and having a maximum width at said outer surface. The set of grooves may be comprised of a subset of grooves which are generally circumferential, a subset of grooves which are generally lateral, or both. “Lateral” refers to grooves which are generally parallel to the axis of rotation of the tire, or trace a zig zag path across the outer surface of the tread.

The profile of one of the grooves is preferably a tapered shape, and more preferably a “V” shape. Alternatively, the profile of a groove may be a truncated “V” shape, a rounded “V” shape, or a half-octagonal shape.

### BRIEF DESCRIPTION OF THE DRAWINGS

FIG. 1 is an isometric view of a tire with a set of grooves.

FIG. 2 is a cross-sectional view of a first preferred embodiment of the groove configuration of this invention.

FIG. 3 is a cross-sectional view of a second preferred embodiment of the groove configuration of this invention.

FIG. 4 is a cross-sectional view of a third preferred embodiment of the groove configuration of this invention.

FIG. 5 is a cross-sectional view of a fourth preferred embodiment of the groove configuration of this invention.

### DETAILED DESCRIPTION OF THE INVENTION

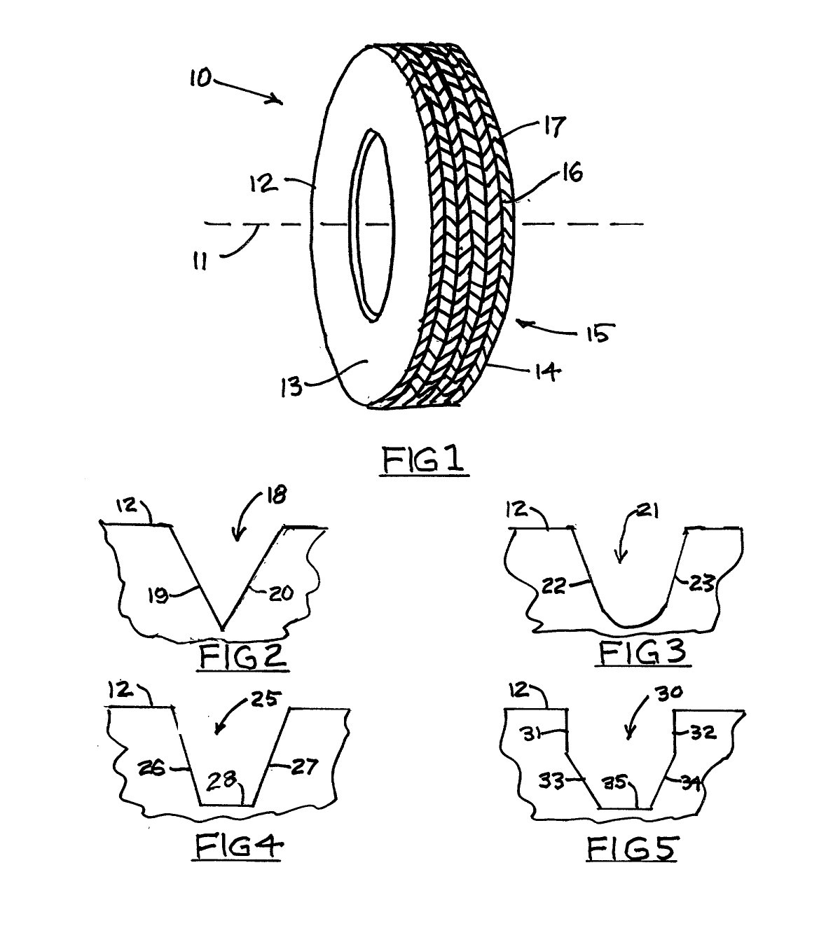

FIG. 1 shows a tire 10, the center of gravity of which has an axis of rotation 11 passing therethrough. The tire 10 has side walls 13 and 14, and tread with an outer surface 12, into which a set of grooves 15 are carved. Grooves 15 comprise a subset of circumferential grooves 16 and a subset of lateral grooves 17. “Circumferential” refers to grooves which traverse outer surface 12 around the circumference of tire 10, tracing a generally circular path. “Lateral” refers to grooves which traverse outer surface 12 from side wall 13 to side wall 14 of tire 10, tracing a path which is generally parallel to axis of rotation 11. The term “lateral” also encompasses grooves which trace a path that zig zags while traversing outer surface 12 in a direction within 45 degrees of being parallel to axis of rotation 11, as shown in FIG. 1.

FIG. 2 shows a first preferred embodiment of a groove 18 configured according to this invention. Groove 18 has a cross-section with a tapered or “V” shape, defined by walls 19 and 20. Walls 19 and 20 each intersect outer surface 12 at an angle larger than 90 degrees and smaller than 135 degrees.

FIG. 3 shows a second preferred embodiment of a groove 21 configured according to this invention. Groove 21 has a cross-section with a rounded “V” shape, defined by walls 22 and 23 and a rounded bottom 24. Walls 22 and 23 each intersect outer surface 12 at an angle larger than 90 degrees and smaller than 135 degrees. Rounded bottom 24 has a radius of curvature that allows for a smooth intersection with walls 22 and 23.

FIG. 4 shows a third preferred embodiment of a groove 25 configured according to this invention. Groove 25 has a cross-section with a truncated “V” shape, defined by walls 26 and 27 and a flat bottom 28. Walls 26 and 27 each intersect outer surface 12 at an angle larger than 90 degrees and smaller than 135 degrees. Flat bottom 28 is generally parallel to outer surface 12.

FIG. 5 shows a second preferred embodiment of a groove 30 configured according to this invention. Groove 30 has a cross-section with a half-octagonal shape, defined by upper walls 31 and 32, lower walls 33 and 34 and a flat bottom 35. Upper walls 31 and 32 are each generally perpendicular to outer surface 12. Lower walls 33 and 34 intersect upper walls 31 and 32, respectively, at an angle larger than 130 degrees and smaller than 160 degrees. Flat bottom 35 is generally parallel to outer surface 12.

It is to be understood that there are other embodiments of this invention which are not described herein, but which nevertheless are within the scope of this invention.

What is claimed is:

1. A tire with a tread having an outer surface, said outer surface of the tread having thereon a set of grooves, each of said grooves extending radially inward from said outer surface and having a maximum width at said outer surface.

2. The tire of claim 1 wherein said set of grooves are generally circumferential.

3. The tire of claim 1 wherein said set of grooves are generally parallel to an axis of rotation of the tire.

4. The tire of claim 1 wherein said set of grooves is comprised of a first subset of grooves which are generally parallel to an axis of rotation of the tire, and a second subset of grooves which are generally circumferential.

5. The tire of claim 1 wherein said set of grooves is comprised of a first subset of grooves which zig zag across said outer surface in a direction within 45 degrees from parallel to an axis of rotation of the tire, and a second subset of grooves which are generally circumferential.

6. The tire of claim 1 wherein said grooves are configured in a tapered shape.

7. The tire of claim 2 wherein said grooves are configured in a tapered shape.

8. The tire of claim 3 wherein said grooves are configured in a tapered shape.

9. The tire of claim 4 wherein said grooves are configured in a tapered shape.

10. The tire of claim 5 wherein said grooves are configured in a tapered shape.

11. The tire of claim 1 wherein said grooves are configured in a truncated “V” shape.

12. The tire of claim 2 wherein said grooves are configured in a truncated “V” shape.

13. The tire of claim 3 wherein said grooves are configured in a truncated “V” shape.

14. The tire of claim 4 wherein said grooves are configured in a truncated “V” shape.

15. The tire of claim 5 wherein said grooves are configured in a truncated “V” shape.

16. The tire of claim 1 wherein said grooves are configured in a rounded “V” shape.

17. The tire of claim 2 wherein said grooves are configured in a rounded “V” shape.

18. The tire of claim 3 wherein said grooves are configured in a rounded “V” shape.

19. The tire of claim 4 wherein said grooves are configured in a rounded “V” shape.

20. The tire of claim 5 wherein said grooves are configured in a rounded “V” shape.

21. The tire of claim 1 wherein said grooves are configured in a half-octagonal shape.

22. The tire of claim 2 wherein said grooves are configured in a half-octagonal shape.

23. The tire of claim 3 wherein said grooves are configured in a half-octagonal shape.

24. The tire of claim 4 wherein said grooves are configured in a half-octagonal shape.

25. The tire of claim 5 wherein said grooves are configured in a half-octagonal shape.
